(19) United States
(12) Patent Application Publication
(10) Pub. No.: US 2005/0185329 A1
(43) Pub. Date: Aug. 25, 2005

(54) Recording disk drive capable of reducing vibration within enclosure

(75) Inventors: Keiichi Miyajima, Kawasaki (JP); Yasuyoshi Asao, Kawasaki (JP); Yoshiaki Koizumi, Kawasaki (JP); Ritsuko Minamisawa, Kawasaki (JP); Yasuhiro Miura, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 10/896,938

(22) Filed: Jul. 23, 2004

(30) Foreign Application Priority Data
Feb. 19, 2004 (JP) 2004-042860

(51) Int. Cl. G11B 17/02

(52) U.S. Cl. 360/99.08; 360/99.12

(57) ABSTRACT

A recording disk is mounted on a hub in a recording disk drive. The hub is mounted on a rotation shaft. The lower end of the rotation shaft is received on a thrust bearing. The packing is interposed between the enclosure and the thrust bearing. The packing serves to protect the inner space of the enclosure from dust. When the rotation shaft, the hub, the thrust bearing, and the like are assembled into the enclosure, an urging force is applied on the upper end of the rotation shaft. The thrust bearing urges the packing against the enclosure. Since the top surface of the hub is set lower than the top end of the rotation shaft, the urging force is reliably received on the rotation shaft. The alignment cannot be deteriorated between the rotation shaft and the hub.

### BACKGROUND OF THE INVENTION

1. Field of the Invention

The present invention relates to a clamp, a spacer and a spindle motor utilized in a recording disk drive such as a hard disk drive (HDD), for example.

2. Description of the Prior Art

A spindle motor is assembled within an enclosure of a hard disk drive (HDD), for example. The spindle motor includes a rotor supported in a stator for relative rotation. A hard disk (HD), a spacer and a clamp are mounted on the rotor. The stator is received on the bottom plate of the enclosure. Ahead actuator is mounted on the enclosure for swinging movement. A head slider is supported at the tip or front end of the head actuator.

Electromagnets are attached to the stator for inducing rotation of the rotor. When electric current is supplied to the electromagnets, the interaction between the electromagnets and permanent magnets on the rotor causes the rotor and the hard disk to rotate. The swinging movement of the head actuator serves to position the head slider at a target recording track on the hard disk during the rotation of the hard disk. An electromagnetic transducer mounted on the head slider is designed to write a magnet bit data on the hard disk.

The rotor should be prevented from suffering from deviation of rotation for achieving a higher recording density on the hard disk. If the deviation of rotation is suppressed, the head slider can accurately be positioned at a target recording track with a higher accuracy. In this case, the hard disk, the clamp and the spacer should be positioned on the rotor with a high accuracy. The center of gravity of the clamp and the spacer must be aligned at the rotation axis of the rotor.

Electromagnetic vibration is transmitted from the electromagnets to the stator when electric current is supplied to the electromagnets. If the vibration frequency of the electromagnetic vibration corresponds to the natural frequency of the spindle motor, the spindle motor heavily vibrates. The vibration is transmitted from the enclosure to the head actuator, namely the head slider. The head slider cannot be positioned at a target recording track.

### SUMMARY OF THE INVENTION

It is accordingly an object of the present invention to provide a recording disk drive capable of relatively easily suppressing deviation of rotation. It is accordingly another object of the present invention to provide a clamp and a spacer greatly useful to realize the aforementioned recording disk drive. It is accordingly another object of the present invention to provide a spindle motor capable of relatively easily suppressing vibration in a recording disk drive.

According to a first aspect of the present invention, there is provided a closed recording disk drive comprising: a rotation shaft; a thrust bearing receiving the bottom end of the rotation shaft; a radial fluid dynamic bearing supporting the rotation shaft for relative rotation around the rotation axis; a hub attached to the rotation shaft so as to receive a recording disk and defining the top surface lower than the top end of the rotation shaft; an enclosure designed to contain the rotation shaft, the thrust bearing, the radial fluid dynamic bearing, the recording disk and the hub so as to receive the thrust bearing; and a packing interposed between the enclosure and the thrust bearing.

The packing is interposed between the enclosure and the thrust bearing in the recording disk drive. The packing seals the inner space of the enclosure. The packing serves to protect the inner space of the enclosure from dust. When the rotation shaft, the hub, the thrust bearing and the radial fluid dynamic bearing are assembled into the enclosure, the packing is urged between the thrust bearing and the enclosure. An urging force is applied on the upper end of the rotation shaft. The urging force is transmitted to the thrust bearing from the lower end of the rotation shaft. The thrust bearing urges the packing against the enclosure. Since the top surface of the hub is set lower than the top or upper end of the rotation shaft, the urging force is reliably received on the rotation shaft. The alignment cannot be deteriorated between the rotation shaft and the hub. In general, the upper end of the rotation shaft is set lower than the level of the top surface of the hub in a conventional recording disk drive. When the rotation shaft, the hub, the thrust bearing and the radial fluid dynamic bearing are assembled into the enclosure, the urging force is received on the hub in the conventional recording disk drive. The alignment cannot sufficiently be maintained between the rotation shaft and the hub.

According to a second aspect of the present invention, there is provided a clamp for a recording disk drive, comprising; a clamp body attached to the tip end of a rotary body so as to hold a recording disk on the rotary body; and an attachment hole formed in the clamp body so as to receive insertion of the rotary body. In this case, the attachment hole defines: a small hole portion positioning the rotary body relative to the clamp body; and a large hole portion continuously connected to the small hole portion, said large hole portion expanding from the small hole portion in the centrifugal direction of the rotary body.

When the clamp is mounted on the rotary body, the rotary body is received in the small hole portion. The small hole portion serves to position the rotary body relative to the clamp. If an urging force is applied to the clamp on the rotary body based on fastening means such as screws, for example, the clamp body gets closer to the rotary body as the screws advance into the rotary body. The clamp body bends upward at the outer periphery. This causes the inner surface of the large hole portion to get closer to the outer surface of the rotary body. Since the large hole portion expands in the centrifugal direction of the rotary body, a sufficient clearance can be established between the inner surface of the large hole portion and the outer surface of the rotary body. Deformation of the clamp body is accordingly accepted. The fastening force can reliably be applied to the clamp body. The clamp is allowed to hold the recording disk on the rotary body with a clamping force as designed.

It is required to suppress deviation of rotation of the rotary body for establishment of a higher recording density. The clamp should be mounted on the rotary body with a higher positional accuracy. The clamp according to the invention allows the inner surface of the small hole portion to closely contact the rotary body. The clamp can thus be positioned relative to the rotary body at a higher accuracy. The center of gravity of the clamp can reliably be aligned with the rotation axis of the rotation body. Deviation of rotation of the rotary body can be suppressed to the uttermost.

In a conventional clamp, an attachment hole forms a cylindrical space. The inner surface of the attachment hole contacts the outer surface of the rotary body. If an urging force is applied to the clamp on the rotary body based on screws, for example, the clamp body gets closer to the rotary body as the screws advance into the rotary body. The clamp body bends upward at the outer periphery. However, since the inner surface of the attachment hole tightly contacts the outer surface of the rotary body, deformation of the clamp body is inhibited. The screws cannot tightly be screwed into the rotary body. The center of gravity of the clamp should be displaced from the rotation axis of the rotary body. The recording density of the magnetic recording disks cannot be improved.

The small hole portion may be defined at one end of the attachment hole, while the large hole portion is designed to extend from the small hole portion to the other end of the attachment hole. The large hole portion may form a space of a truncated cone tapered toward the small hole portion.

The clamp is usually assembled in a recording disk drive. The recording disk drive may thus include: a rotary body; a recording disk attached to the rotary body; a clamp attached to the tip end of the rotary body so as to hold the recording disk against a flange formed in the rotary body; and an attachment hole formed in the clamp so as to receive insertion of the rotary body. In this case, the attachment hole should define: a small hole portion positioning the rotary body relative to the clamp; and a large hole portion continuously connected to the small hole portion, said large hole portion expanding from the small hole portion in a centrifugal direction of the rotary body. The small hole portion may be defined at a position closer to the flange. The large hole portion may be defined at a position remoter from the flange. The large hole portion may extend from the small hole portion toward the top end of the attachment hole.

According to a third aspect of the present invention, there is provided a spacer mounted on a rotary body between recording disks in a recording disk drive, said spacer defining: a small hole portion designed to form a cylindrical space; and a large hole portion designed to form a space of a truncated cone continuous with the cylindrical space, said truncated cone having the axis common to the cylindrical space and tapered toward the cylindrical space, wherein the generatrix of the truncated cone intersects the generatrix of the cylindrical space within a plane including the rotation axis by an angle smaller than 45 degrees.

When the spacer is mounted on the rotary body, the large hole portion receives insertion of the rotary body. Since the large hole portion expands most at the opening, the rotary body is allowed to easily get into the large hole portion. Moreover, since the generatrix of the truncated cone intersects the generatrix of the cylindrical space within a plane including the rotation axis by an angle smaller than 45 degrees, the rotary body is smoothly guided toward the small hole portion. Thereafter, the tip end of the rotary body reaches the small hole portion. The tolerance is set extremely small between the inner surface of the small hole portion and the outer periphery of the rotary body, the spacer can be positioned relative to the rotary body with a higher accuracy. The center of gravity of the spacer can reliably be aligned with the rotation axis of the rotary body. Deviation of rotation of the rotary body can accordingly be suppressed to the uttermost. The aforementioned angle may be set smaller than 30 degrees.

As describe above, it is required to suppress deviation of rotation for establishment of a higher recording density. The spacer should be mounted on the rotary body with a higher positional accuracy. A higher recording density requires a reduced tolerance between the inner surface of the small hole portion and the outer periphery of the rotary body. In a conventional spacer, an attachment hole forms a cylindrical space beveled at the openings. Thin spaces of a truncated cone are defined at the openings of the cylindrical space to get tapered toward the cylindrical space. However, the generatrix of the individual truncated cone is designed to intersect the generatrix of the cylindrical space by an angle exactly equal to 45 degrees in the conventional spacer. When the tip end of the rotary body collides against the inner surface of the space of the truncated cone, the tip end of the rotary body is hardly inserted into the cylindrical space. It is more difficult to insert the rotary body into the spacer of the conventional type if tolerance gets smaller between the inner surface of the attachment hole and the outer periphery of the rotary body. The assembling operation suffers from less efficiency when the spacer is to be mounted on the rotary body.

The spacer may define: a small hole portion designed to form a cylindrical space; a first large hole portion designed to form a space of a truncated cone continuous with one end of the cylindrical space, said truncated cone having the axis common to the cylindrical space and tapered toward the cylindrical space; and a second large hole portion designed to form a space of a truncated cone continuous with the other end of the cylindrical space, said truncated cone having the axis common to the cylindrical space and tapered toward the cylindrical space.

The spacer of the aforementioned types may be assembled into a recording disk drive. In this case, the recording disk drive may include: rotary body; and recording disks mounted on the rotary body. The spacer may be mounted on the rotary body between the recording disks. The spacer may define: a small hole portion forming a cylindrical space; and a large hole portion continuously connected to the small hole portion, said large hole portion defining a space of a truncated cone tapered toward the cylindrical space. Additionally, the generatrix of the truncated cone intersects the generatrix of the cylindrical space within a plane including the rotation axis by an angle smaller then 45 degrees. Likewise, the recording disk drive may include: rotary body; and recording disks mounted on the rotary body. The spacer may be mounted on the rotary body between the recording disks. The spacer may define: a small hole portion forming a cylindrical space; and first and second large hole portions continuously connected to opposite ends of the cylindrical space, said large hole portions respectively defining a space of a truncated cone tapered toward the cylindrical space. Additionally, the generatrix of the truncated cone intersects the generatrix of the cylindrical space within a plane including the rotation axis by an angle smaller than 45 degrees.

According to a fourth aspect of the present invention, there is provided a spindle motor for a recording disk drive, comprising: a rotor; a stator designed to support the rotor for relative rotation; an electromagnet attached to the stator; and a depression formed in the stator and designed to form a thinner portion.

When electric current is supplied to the electromagnet, electromagnetic vibration is transmitted to the stator from the electromagnet. If the frequency of the vibration corresponds to the natural frequency of any component of the stator, the vibration of the stator is amplified. The spindle motor according to the invention enables reduction in the rigidity of the stator based on the thinner portion. In general, the frequency of the vibration depends on the rigidity. If the depression is properly designed, the natural frequency of the stator can be kept away from the frequency of the electromagnetic vibration. The increase of the vibration can be suppressed to the uttermost in the stator.

The spindle motor of the type may be assembled into a recording disk drive. In this case, the recording disk drive may include: a recording disk; a rotor designed to support the recording disk; a stator designed to support the rotor for relative rotation; an electromagnet attached to the stator; a depression formed in the stator and designed to form a thinner portion; an enclosure receiving the stator; a head actuator coupled to a support shaft standing from the enclosure for relative rotation; and a head slider supported at the tip end of the head actuator and opposed to the surface of the recording disk.

The recording disk drive enables reduction in the rigidity of the stator based on the thinner portion as described above. The natural frequency of the stator can be kept away from the frequency of the electromagnetic vibration. The increase of the vibration can be suppressed to the uttermost in the stator. The head actuator is prevented from receiving the vibration from the enclosure. The head slider can be prevented from vibration in the head actuator. This contributes to establishment of a higher recording density.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the inner structure of a hard disk drive (HDD) as a specific example of a recording disk drive;

FIG. 2 is an enlarged sectional view, taken along the line 2-2 in FIG. 1, for schematically illustrating the structure of a spindle motor according to a first example of the present invention;

FIG. 3 is an enlarged partial sectional view of the spindle motor for schematically illustrating the structure of a clamp;

FIG. 4 is an enlarged partial sectional view of the spindle motor for schematically illustrating the structure of an annular spacer;

FIG. 5 is an enlarged sectional view of the spindle motor for schematically illustrating the annular spacer when the annular spacer is to be mounted on a spindle hub;

FIG. 6 is an enlarged sectional view of the spindle motor for schematically illustrating the clamp when the clamp is to be mounted on the spindle hub;

FIG. 7 is an enlarged sectional view of the HDD for schematically illustrating the spindle motor when the spindle motor is to be mounted on an enclosure of the HDD;

FIG. 8 is an enlarged sectional view, corresponding to FIG. 2, for schematically illustrating the structure of a spindle motor according to a second embodiment of the present invention; and

FIG. 9 is an enlarged sectional view, corresponding to FIG. 8, for schematically illustrating the structure of a spindle motor according to a modification of the second embodiment.

### DESCRIPTION OF THE PREFERRED EMBODIMENTS

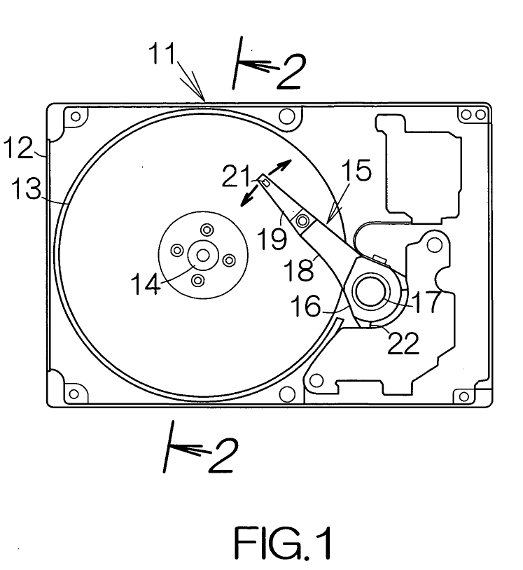

FIG. 1 schematically illustrates the inner structure of a hard disk drive (HDD) 11 as an example of a recording disk drive or storage device according to an embodiment of the present invention. The HDD 11 includes a box-shaped main enclosure 12 defining an inner space of a flat parallelepiped for example. At least one magnetic recording disk 13 is mounted on the driving shaft of a spindle motor 14 within the main enclosure 12. The spindle motor 14 is allowed to drive the magnetic recording disk 13 for rotation at a higher revolution speed such as 7,200 rpm, 10,000 rpm, 15,000 rpm, or the like, for example. A cover, not shown, is coupled to the main enclosure 12 so as to define the closed inner space between the main enclosure 12 and the cover itself. A packing is interposed between the main enclosure 12 and the cover.

A head actuator 15 is also accommodated in the inner space of the main enclosure 12. The head actuator 15 comprises an actuator block 16. The actuator block 16 is coupled to a vertical support shaft 17 standing from the bottom plate of the main enclosure 12 for relative rotation. Rigid actuator arms 18 are defined in the actuator block 16 so as to extend in the horizontal direction from the vertical support shaft 17. The actuator arms 18 are related to the front and back surfaces of the magnetic recording disk 13. The actuator block 16 may be made of aluminum. Molding process may be employed to form the actuator block 16.

Head suspensions 19 are fixed to the corresponding tip ends of the actuator arms 18. The individual head suspension 19 extends forward from the tip end of the actuator arm 18. A flying head slider 21 is supported on the front end of the head suspension 19. The flying head sliders 21 are in this manner connected to the actuator block 16. The flying head sliders 21 are opposed to the surfaces of the magnetic recording disk or disks 13.

An electromagnetic transducer, not shown, is mounted on the flying head slider 21. The electromagnetic transducer may include a read element and a write element. The read element may include a giant magnetoresistive (GMR) element or a tunnel-junction magnetoresistive (TMR) element designed to discriminate magnetic bit data on the magnetic recording disk 13 by utilizing variation in the electric resistance of a spin valve film or a tunnel-junction film, for example. The write element may include a thin film magnetic head designed to write magnetic bit data into the magnetic recording disk 13 by utilizing a magnetic field induced at a thin film coil pattern.

The head suspension 19 serves to urge the flying head slider 21 toward the surface of the magnetic recording disk 13. When the magnetic recording disk 13 rotates, the flying head slider 21 is allowed to receive airflow generated along the rotating magnetic recording disk 13. The airflow serves to generate a positive pressure or lift on the flying head slider 21. The flying head slider 21 is thus allowed to keep flying above the surface of the magnetic recording disk 13 during the rotation of the magnetic recording disk 13 at a higher stability established by the balance between the urging force of the head suspension 19 and the lift.

A power source 22 such as a voice coil motor (VCM) is connected to the actuator block 17. The power source 22 is designed to drive the actuator block 17 for rotation around the support shaft 16. The rotation of the actuator block 17 induces the swinging movement of the actuator arms 18 and the head suspensions 19. When the actuator arm 18 is driven to swing about the support shaft 16 during the flight of the flying head slider 21, the flying head slider 21 is allowed to cross the recording tracks defined on the magnetic recording disk 13 in the radial direction of the magnetic recording disk 13. This radial movement serves to position the flying head slider 21 right above a target recording track on the magnetic recording disk 13. As conventionally known, in the case where two or more magnetic recording disks 13 are incorporated within the inner space of the main enclosure 12, a pair of the actuator arm 18 as well as a pair of the head suspension 19 is disposed between the adjacent magnetic recording disks 13.

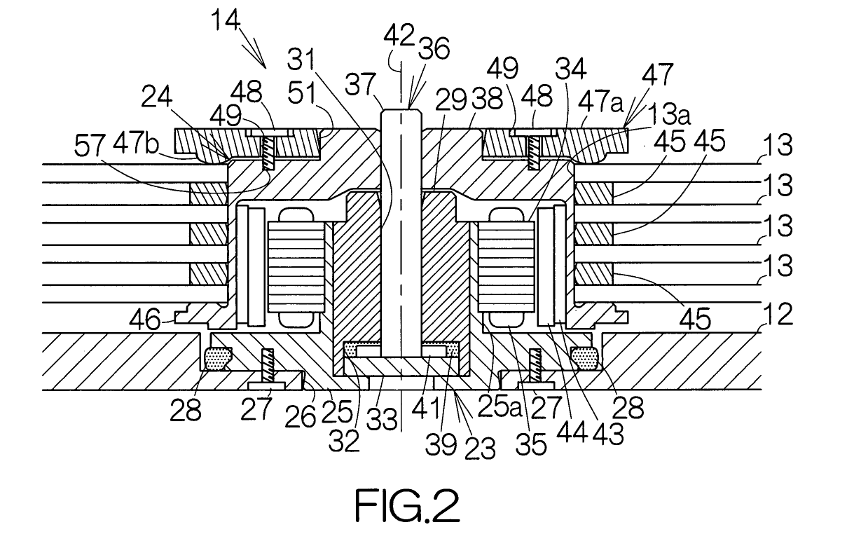

FIG. 2 illustrates the structure of the spindle motor 14 according to a first embodiment of the present invention. The spindle motor 14 includes a stator 23 and a rotor 24. The rotor 24 is supported in the stator 23 for relative rotation. The stator 23 includes a bracket 25 received on the main enclosure 12. The bracket 25 is received in a receiving hole 26 formed in the bottom plate of the main enclosure 12. A cylindrical portion 25a is formed on the bracket 25. The cylindrical portion 25a stands upright from the upper surface of the basement of the bracket 25. The bracket 25 may be fixed with screws 27 on the main enclosure 12, for example. The bracket 25 may be cut out of a mass of aluminum, or the like.

A packing 28 is interposed between the bracket 25 and the main enclosure 12. The packing 28 may take the form of an annularity, for example. The packing 28 may be made of an elastic resin material such as a rubber, for example. The packing 28 is tightly contact the bracket 25 and the main enclosure 12. The packing 28 serves to protect the main enclosure 12 from dust passing through the receiving hole 26.

The stator 23 includes a sleeve 29 received in the cylindrical portion 25a. First and second columnar spaces 31, 32 are defined within the sleeve 29. The second columnar space 32 is formed continuous with the first columnar space 31. The diameter of the second columnar space 32 is set larger than that of the first columnar space 31. The sleeve 31 may be made from a metallic material such as brass, stainless steel, or the like. A thrust plate 33 is fitted in the lower opening of the sleeve 29. The thrust plate 33 is designed to seal the lower opening of the sleeve 29.

The stator 23 includes stator cores 34 coupled to the outer surface of the cylindrical portion 25a, and electromagnets or coils 35 wound around the stator cores 34. The individual stator core 34 comprises stacked metallic thin plates.

The rotor 24 includes a rotary body 36. The rotary body 36 includes a rotation shaft 37, and a spindle hub 38 fixed to the rotation shaft 37. The rotation shaft 37 is received in the first and second columnar spaces 31, 32. Fluid such as oil 39 is filled between the rotation shaft 37 and the sleeve 29. The rotation shaft 37 is supported in the sleeve 29 in this manner. A disciform thrust flange 41 is fixed to the rotation shaft 37. The thrust flange 41 is contained within the second cylindrical space 32. The upper surface of the thrust plate 33 is opposed to the bottom surface of the thrust flange 41. The rotation shaft 37 and the thrust flange 41 may be made from a metallic material such as brass, a stainless steel, or the like.

A columnar inner space is defined within the spindle hub 38. The stator 23 is contained within the inner space. The rotation shaft 37 is tightly inserted into a through bore defined in the upper surface of the spindle hub 38. An adhesive may be utilized to fix the rotation shaft 37 to the spindle hub 38, for example. The spindle hub 38 is in this manner connected to the bracket 25 for relative rotation around the rotation axis 42 of the rotation shaft 37. The level of the upper surface of the spindle hub 38 is set lower than that of the top end of the rotation shaft 37. In other words, the rotation shaft 37 is designed to protrude from the upper surface of the spindle hub 38.

The inner surface of the spindle hub 38 is opposed to the outer cylindrical surface of the cylindrical portion 25a. A yoke 43 and permanent magnets 44 are fixed to the inner surface of the spindle hub 38. The permanent magnets 44 are thus opposed to the coils 35. When electric current is supplied to the coils 35, the magnetic field generated at the coils 35 serves to induce the rotation of the rotary body 36 or spindle hub 38 around the rotation axis 42.

For example, four magnetic recording disks 13 are mounted on the spindle hub 38. A through hole 13a is defined at the center of the individual magnetic recording disk 13 so as to receive the spindle hub 38. An annular spacer 45 is interposed between the adjacent magnetic recording disks 13 around the spindle hub 38. The annular spacers 45 serve to maintain a predetermined space between the adjacent magnetic recording disks 13.

A flange 46 is formed on the spindle hub 38. The flange 46 extends outward from the lower end of the spindle hub 38. The lowest magnetic recording disk 13 is received on the flange 46. A clamp 47 is attached to the upper end of the spindle hub 38. The clamp 47 includes a clamp body 47a. Four screws 48 are utilized to fix the clamp body 47a to the spindle hub 38, for example. Through bores 49 may be defined in the clamp body 47a so as to receive the screws 48. An attachment hole 51 is defined in the clamp body 47a so as to receive insertion of the spindle hub 38. Protrusions 47b are defined in the clamp body 47a. The protrusions 47b are designed to contact the surface of the uppermost magnetic recording disk 13. The magnetic recording disks 13 and the annular spacers 45 are held between the clamp 47 and the flange 46 in this manner.

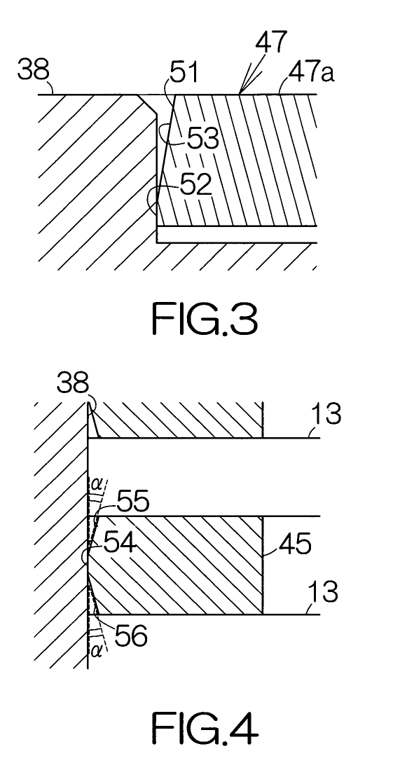

As shown in FIG. 3, a small hole portion 52 is defined in the attachment hole 51. The small hole portion 52 is designed to position the spindle hub 38 relative to the clamp body 47a. The small hole portion 47a forms a cylindrical space. The inner surface of the small hole portion 52 contacts the outer cylindrical surface of the spindle hub 38. The inner diameter of the small hole portion 52 corresponds to the minimum diameter of the attachment hole 51 in the clamp body 47a. The attachment hole 51 defines the small hole portion 52 at the end closer to the flange 46, namely at the lowest end.

A large hole portion 53 is also defined in the attachment hole 51. The large hole portion 52 is continuously connected to the small hole portion 51. The large hole portion 53 expands from the small hole portion 52 in the centrifugal direction of the spindle hub 38. The large hole portion 53 extends from the small hole portion 52 toward the other end or highest end of the attachment hole 51. The large hole portion 53 forms a space of a truncated cone tapered toward the small hole portion 52. The inner surface of the large hole portion 53 keeps distanced from the outer surface of the spindle hub 38 in this manner.

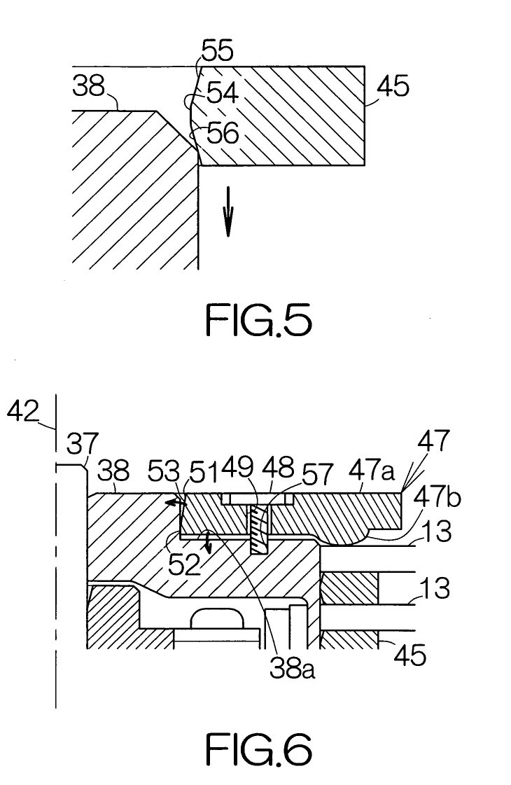

As shown in FIG. 4, a small hole portion 54 is defined in the individual annular spacer 45. The small hole portion 54 forms a cylindrical space. The inner surface of the small hole portion 54 contacts the outer cylindrical surface of the spindle hub 38. The inner diameter of the small hole portion 54 corresponds to the minimum inner diameter of the annular spacer 45. The small hole portion 54 is designed to position the spindle hub 38 relative to the annular spacer 45.

First and second large hole portions 55, 56 are defined in the individual annular spacer 45. The first large hole portion 55 forms a space of a truncated cone continuously connected to one end or the upper end of the cylindrical space. The truncated cone has the axis common to the cylindrical space and tapered toward the cylindrical space. The second large hole portion 56 also forms a space of a truncated cone continuously connected to the other end or lower end of the cylindrical space. The truncated cone likewise has the axis common to the cylindrical space and tapered toward the cylindrical space. The openings of the first and second large hole portions 55, 56 establish the maximum inside diameter of the annular spacer 45. The generatrices of the truncated cones are designed to intersect the generatrix of the cylindrical space within a plane including the rotation axis 42 by an angle α smaller than 45 degrees. Here, the angle α may be set smaller than 30 degrees. It should be noted that the first large hole portion 55 may be omitted in the spacer 45.

Now, assume that the rotation shaft 37 starts rotating along with the magnetic recording disks 13. When electric current is supplied to the coils 35, a driving power is generated between the coils 35 and the permanent magnets 44. When the rotation shaft 37 starts rotating, the oil 39 is allowed to flow along the inner surface of the sleeve 29. The oil 39 serves to generate dynamic pressure. The dynamic pressure establishes a predetermined constant gap between the outer surface of the rotation shaft 37 and the inner surface of the sleeve 29. The dynamic pressure also establishes a predetermined constant gap between the bottom surface of the thrust flange 41 and the upper surface of the thrust plate 33. The rotation axis of the rotation shaft 37 thus aligns with the aforementioned rotation axis 42. The rotation shaft 37 along with the magnetic recording disks 13 keeps smoothly rotating in this manner. Here, the sleeve 29 and the oil 39 function as a radial fluid dynamic bearing to the rotation axis 37. Likewise, the thrust plate 33 or bracket 25 and the oil 39 function as a thrust fluid dynamic bearing. The radial fluid dynamic bearing and the thrust fluid dynamic bearing forms a fluid dynamic bearing apparatus. When the coils 35 stops receiving the electric current, the driving force to the rotation shaft 37 disappears. The rotation shaft 37 stops rotating along with the magnetic recording disks 13. The oil 39 stops flowing. The dynamic pressure disappears, so that the lower end of the rotation shaft 37 is received on the upper surface of the thrust plate 33.

Next, assume that the magnetic recording disks 13, the annular spacers 45 and the clamp 47 are to be mounted on the spindle motor 14. The first magnetic recording disk 13 is mounted on the flange 46. The spindle hub 38 is received in the through hole 13a of the recording disk 13. The annular spacer 45 is then mounted on the spindle hub 38. As shown in FIG. 5, for example, the spindle hub 38 is inserted into the second large hole portion 56 of the annular spacer 45. The second large hole portion 56 provides the maximum diameter at the opening, so that the spindle hub 38 is allowed to easily get into the second large hole portion 56. Moreover, the second large hole portion 56 has the aforementioned angle α as described above, so that the spindle hub 38 is smoothly guided toward the small hole portion 54. Thereafter, the upper end of the spindle hub 38 reaches the small hole portion 54. Since the tolerance is set extremely small between the inner diameter of the small hole portion 54 and the outer diameter of the spindle hub 38, the annular spacer 45 can be positioned relative to the spindle hub 38 with a higher accuracy. The center of gravity of the annular spacer 45 can reliably be aligned with the rotation axis 42. Deviation of rotation of the spindle motor 14 can accordingly be suppressed to the uttermost. Afterward, the magnetic recording disks 13 and the annular spacers 45 are alternately mounted on the spindle hub 38.

It is required to suppress deviation of rotation for establishment of a higher recording density. The annular spacers 45 must be mounted on the spindle hub 38 with a higher positional accuracy. A higher recording density requires a reduced tolerance between the inner diameter of the small hole portion 54 and the outer diameter of the spindle hub 38. In a conventional annular spacer, an attachment hole forms a cylindrical space beveled at the openings. Thin spaces of a truncated cone are defined at the openings of the cylindrical space to get tapered toward the cylindrical space. However, the generatrix of the individual truncated cone is designed to intersect the generatrix of the cylindrical space by an angle exactly equal to 45 degrees. When the upper end of the spindle hub collides against the inner surface of the space of the truncated cone, the upper end of the spindle hub is hardly inserted into the cylindrical space. It is more difficult to insert the spindle hub into the annular spacer of the type if tolerance gets smaller between the inner diameter of the attachment hole and the outer diameter of the spindle hub. The assembling operation suffers from less efficiency when the annular spacer is to be mounted on the spindle hub.

After the uppermost recording disk 13 is mounted on the spindle hub 38, the clamp 47 is mounted on the spindle hub 38. The spindle hub 38 is received into the small hole portion 52 of the attachment hole 51. The small hole portion 52 positions the spindle hub 38 relative to the clamp 47. The through bores 49 of the clamp body 47a may previously be positioned at the screw holes 57 defined in the spindle hub 38. The screws 48 are then inserted through the through bores 49 and thereafter screwed into the screw holes 57 at a regular fastening torque. As shown in FIG. 6, for example, the protrusions 47b contact the surface of the uppermost magnetic recording disk 13. When the screws 48 are further screwed into the screw holes 57, the clamp body 47a gets closer to a step 38a of the spindle hub 38. The clamp body 47a bends upward at the outer periphery. This causes the inner surface of the large hole portion 53 to get closer to the outer surface of the spindle hub 38. Since the large hole portion 53 forms a space of a truncated cone as described above, a sufficient clearance can be established between the large hole portion 53 and the spindle hub 38. The deformation of the clamp body 47a is acceptable. The fastening force of the screws 48 can reliably be applied to the clamp body 47a. The protrusions 47b are allowed to hold the magnetic recording disks 13 at a clamping force as designed. In addition, the inner surface of the small hole portion 52 reliably contacts the outer surface of the spindle hub 38, so that the clamp 47 can be positioned at the spindle hub 38 at a higher accuracy. The center of gravity of the clamp 47 can reliably be aligned with the rotation axis 42. Deviation of rotation of the spindle motor 14 can be suppressed to the uttermost. Furthermore, the deformation of the clamp body 47a is acceptable, so that the screws 47 and the through bores 49 are prevented from receiving an abnormal load.

In a conventional clamp, an attachment hole forms a cylindrical space. The inner surface of the attachment hole contacts the outer surface of the spindle hub. When screws are screwed into the spindle hub, protrusions are forced to contact the uppermost magnetic recording disk in the same manner as described above. However, since the inner surface of the attachment hole tightly contacts the outer surface of the spindle hub, deformation of the clamp body is inhibited. The screws cannot further be screwed anymore. The center of gravity of the clamp should be displaced from the rotation axis of the spindle hub. The recording density of the magnetic recording disks cannot be improved. Moreover, not only a clamping force cannot be obtained as designed, but also the screws and the screw holes suffer from an abnormal load.

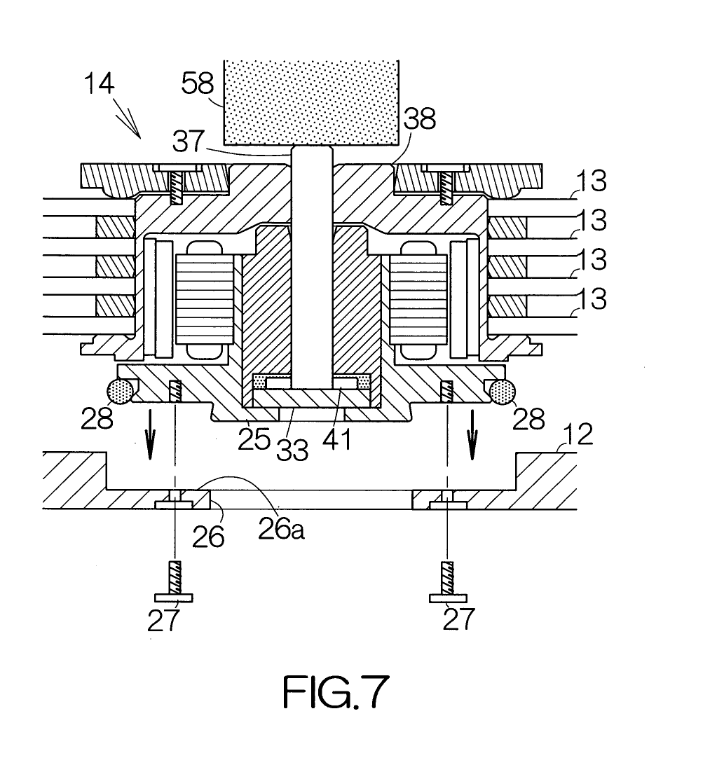

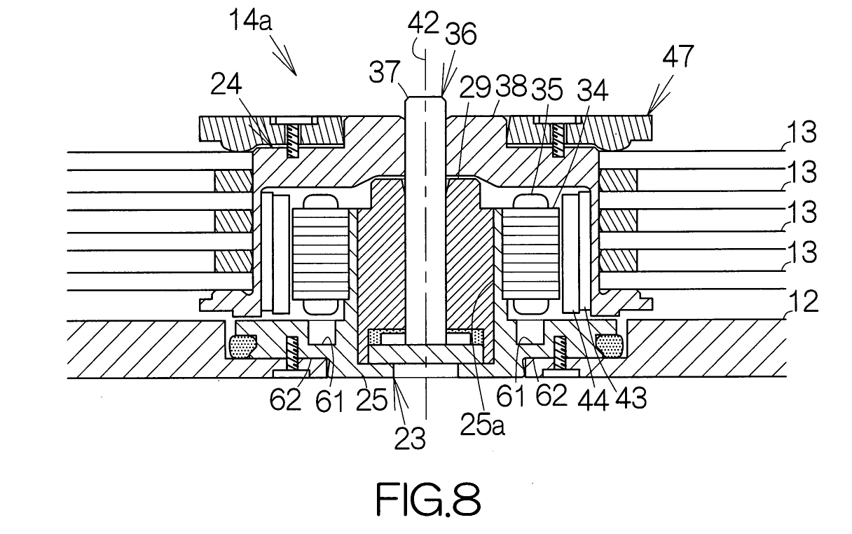

As shown in FIG. 7, for example, the spindle motor 14 is then assembled into the main enclosure 12. The packing 28 is previously attached to the bracket 25. When the spindle motor 14 is received in the receiving hole 26, the packing 28 is interposed between the bottom surface of the bracket 25 and a step 26a of the receiving hole 26. An urging member 58 is employed to apply the urging force at the upper end of the rotation shaft 37. The urging force is transmitted from the bottom end of the rotation shaft 37 to the thrust plate 33, namely the bracket 25. The bracket 25 urges the packing 28 against the step 26a. When the bottom surface of the bracket 25 has been received on the step 26a, the screws 27 is inserted into the main enclosure 12. The spindle motor 14 is thus fixed to the main enclosure 12 in this manner.

The upper surface of the spindle hub 38 is set lower than the top end of the rotation shaft 37 in the aforementioned HDD 11. The urging force is reliably received on the rotation shaft 37. The alignment cannot be deteriorated between the rotation shaft 37 and the spindle hub 38. On the other hand, the top end of the rotation shaft is set lower than the upper surface of the spindle hub in a conventional HDD. The urging force is received on the upper surface of the spindle hub when the spindle motor is assembled into the HDD. The alignment cannot sufficiently be maintained between the rotation shaft and the spindle hub.

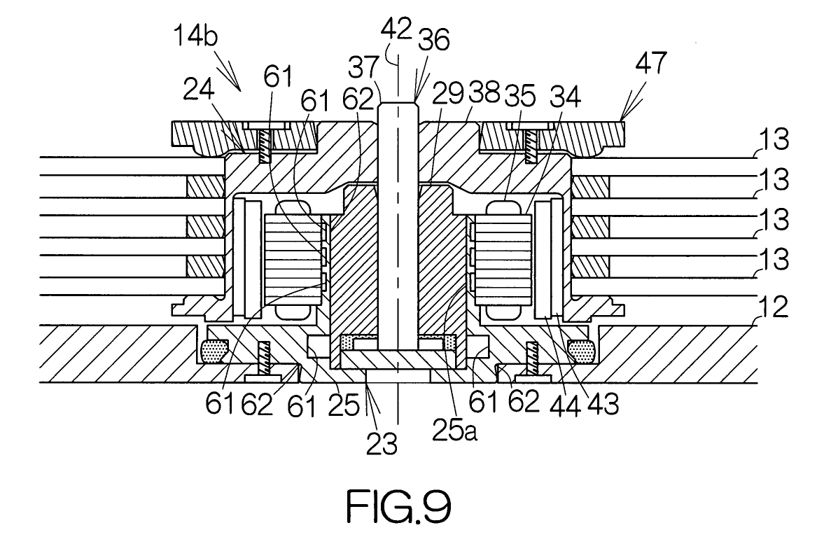

FIG. 8 illustrates the structure of the spindle motor 14a according to a second embodiment of the present invention. A depression 61 is defined in the bracket 25 in the spindle motor 14a. Here, the depression 61 is located on the bracket 25 outside the cylindrical portion 25a. The depression 61 is designed to extend in the circumferential direction of the cylindrical portion 25a, for example. The depression 61 may be an elongated groove extending in the circumferential direction of the cylindrical portion 25a. Alternatively, depressions 61 may be arranged in a row in the circumferential direction of the cylindrical portion 25a. The depression 61 serves to form a thinner portion 62 in the bracket 25. The rigidity of the bracket 25 is decreased at the area of the thinner portion 62. Like reference numerals are attached to components or structures equivalent to those of the aforementioned first embodiment.

When electric current is supplied to the coils 35, electromagnetic vibration induced in the coils 35 is transmitted to the bracket 25. If the frequency of the electromagnetic vibration corresponds to the natural frequency of the bracket 25, the vibration of the bracket 25 is greatly enhanced. The vibration is then transmitted to the head actuator 15 through the bottom plate of the main enclosure 12. The head slider 21 vibrates in the head actuator 15. A reduced vibration contributes to a higher recording density.

The thinner portion 62 based on the depression 61 serve to decrease the rigidity of the bracket 25. Generally, the frequency of vibration depends on the rigidity. If the depression 61 is properly designed, the natural frequency of the bracket 25 can be kept away from the frequency of the electromagnetic vibration. The increase of vibration can be suppressed to the uttermost in the bracket 25. The head slider 21 can reliably be prevented from receiving transmission of vibration.

In a conventional spindle motor, the frequency of the electromagnetic vibration is shifted by changing design such as means for supporting the cores, condition for magnetizing the coils, structure of the bearing apparatus. Operations such as redesign, experiment, and examination are repeated. It takes a long time to accomplishing the design of products. On the other hand, according to the spindle motor 14a of the present invention, the depression 61 serves to suppress the vibration in a facilitated manner.

The vibration of the spindle motor 14a is measured for deciding the arrangement and size of the depression 61. A vibroscope is attached to the spindle motor 14a. The vibration of the bracket 25 is measured based on the vibroscope. The position and extent of the depression 61 are determined based on the measurement. A drill may be employed to form the depression 61.

In addition, as shown in FIG. 9, the depression 61 may be formed in the cylindrical portion 25a of the bracket 25, for example. Otherwise, the depression 61 may be formed in the other area of the bracket 25. Like reference numerals are attached to components or structures equivalent to those of the aforementioned first and second embodiments.

A ball bearing apparatus or a rolling bearing apparatus, or the other types of a bearing apparatus may be employed in the aforementioned spindle motor 14, 14a, 14b, in addition to the aforementioned fluid dynamic bearing apparatus.

1. A closed recording disk drive comprising:
a rotation shaft;
a thrust bearing receiving a bottom end of the rotation shaft;
a radial fluid dynamic bearing supporting the rotation shaft for relative rotation around a rotation axis;
a hub attached to the rotation shaft so as to receive a recording disk and defining a top surface lower than a top end of the rotation shaft;
an enclosure designed to contain the rotation shaft, the thrust bearing, the radial fluid dynamic bearing, the recording disk and the hub so as to receive the thrust bearing; and
a packing interposed between the enclosure and the thrust bearing.

2. A clamp for a recording disk drive, comprising;
a clamp body attached to a tip end of a rotary body so as to hold a recording disk on the rotary body; and
an attachment hole formed in the clamp body so as to receive insertion of the rotary body, wherein
said attachment hole defines:
a small hole portion positioning the rotary body relative to the clamp body; and
a large hole portion continuously connected to the small hole portion, said large hole portion expanding from the small hole portion in a centrifugal direction of the rotary body.

3. The clamp according to claim 2, wherein the small hole portion is defined at one end of the attachment hole, and the large hole portion is designed to extend from the small hole portion to the other end of the attachment hole.

4. The clamp according to claim 2, wherein the large hole portion forms a space of a truncated cone tapered toward the small hole portion.

5. A recording disk drive comprising:
a rotary body;
a recording disk attached to the rotary body;
a clamp attached to a tip end of the rotary body so as to hold the recording disk against a flange formed in the rotary body; and
an attachment hole formed in the clamp so as to receive insertion of the rotary body, wherein
said attachment hole defines:
a small hole portion positioning the rotary body relative to the clamp; and
a large hole portion continuously connected to the small hole portion, said large hole portion expanding from the small hole portion in a centrifugal direction of the rotary body.

6. The recording disk drive according to claim 5, wherein the small hole portion is defined at a position closer to the flange, and the large hole portion is defined at a position remoter from the flange, said large hole portion extending from the small hole portion toward a top end of the attachment hole.

7. The recording disk drive according to claim 6, wherein the large hole portion forms a space of a truncated cone tapered toward the small hole portion.

8. A spacer mounted on a rotary body between recording disks in a recording disk drive, said spacer defining:
a small hole portion designed to form a cylindrical space; and
a large hole portion designed to form a space of a truncated cone continuous with the cylindrical space, said truncated cone having an axis common to the cylindrical space and tapered toward the cylindrical space, wherein
a generatrix of the truncated cone intersects a generatrix of the cylindrical space within a plane including a rotation axis by an angle smaller than 45 degrees.

9. The spacer according to claim 8, wherein the angle is set smaller than 30 degrees.

10. A spacer mounted on a rotary body between recording disks in a recording disk drive, said spacer defining:
a small hole portion designed to form a cylindrical space;
a first large hole portion designed to form a space of a truncated cone continuous with one end of the cylindrical space, said truncated cone having an axis common to the cylindrical space and tapered toward the cylindrical space; and
a second large hole portion designed to form a space of a truncated cone continuous with the other end of the cylindrical space, said truncated cone having an axis common to the cylindrical space and tapered toward the cylindrical space, wherein
a generatrix of the truncated cones intersects a generatrix of the cylindrical space within a plane including a rotation axis by an angle smaller than 45 degrees.

11. The spacer according to claim 10, wherein the angle is set smaller than 30 degrees.

12. A recording disk drive comprising;
a rotary body;
recording disks mounted on the rotary body; and
a spacer mounted on the rotary body between the recording disks, wherein
said spacer defines:
a small hole portion forming a cylindrical space; and
a large hole portion continuously connected to the small hole portion, said large hole portion defining a space of a truncated cone tapered toward the cylindrical space, wherein
a generatrix of the truncated cone intersects a generatrix of the cylindrical space within a plane including a rotation axis by an angle smaller then 45 degrees.

13. A recording disk drive comprising:
a rotary body;
recording disks mounted on the rotary body; and
a spacer mounted on the rotary body between the recording disks, wherein
said spacer defines:
a small hole portion forming a cylindrical space; and
first and second large hole portions continuously connected to opposite ends of the cylindrical space, said large hole portions respectively defining a space of a truncated cone tapered toward the cylindrical space, wherein
a generatrix of the truncated cone intersects a generatrix of the cylindrical space within a plane including a rotation axis by an angle smaller than 45 degrees.

14. A spindle motor for a recording disk drive, comprising:
a rotor;
a stator designed to support the rotor for relative rotation;
an electromagnet attached to the stator; and
a depression formed in the stator and designed to form a thinner portion.

15. A recording disk drive comprising:
a recording disk;
a rotor designed to support the recording disk;
a stator designed to support the rotor for relative rotation;
an electromagnet attached to the stator;
a depression formed in the stator and designed to form a thinner portion;
an enclosure receiving the stator;
a head actuator coupled to a support shaft standing from the enclosure for relative rotation; and
a head slider supported at a tip end of the head actuator and opposed to a surface of the recording disk.
